(19) United States
(12) Patent Application Publication
(10) Pub. No.: US 2017/0321560 A1
(43) Pub. Date: Nov. 9, 2017

(54) GAS TURBINE ENGINE HAVING A VANE ASSEMBLY

(71) Applicant: United Technologies Corporation, Farmington, CT (US)

(72) Inventors: Peter Balawajder, West Hartford, CT (US); Benjamin F. Hagan, Winston-Salem, NC (US); Jeffrey Michael Jacques, East Hartford, CT (US)

(21) Appl. No.: 15/147,954

(22) Filed: May 6, 2016

(51) Int. Cl. F01D 5/30; F01D 9/02

(52) U.S. Cl. CPC F01D 5/3007; F01D 9/02; F05D 2240/80

(57) ABSTRACT

A vane assembly for a gas turbine engine includes an outer platform, an inner platform, a vane, and a seal. The outer platform is disposed proximate a case. The outer platform has a first rail extending towards the case. The first rail has a first face, a second face disposed opposite the first face, and a first opening extending from the first face towards the second face. The inner platform is disposed opposite the outer platform. The vane extends between the inner platform and the outer platform. The seal is received within a slotted region that is disposed between the first face and the second face.

### BACKGROUND

Gas turbine engines are provided with a plurality of vanes such as turbine vanes or compressor vanes. The vanes are stationary and direct a flow of gases against airfoils of rotating turbine blades or compressor blades. The vanes include a mounting rail that is solid and fairly stiff. The mounting rail is generally disposed away from the flow path of the gases that are directed by the vanes. The mounting rail may experience high stresses that may lead to a life shortfall of the vane.

Accordingly, it is desirable to provide a vane that experiences reduced stresses proximate the mounting rail.

### BRIEF DESCRIPTION

According to an embodiment of the present disclosure, a gas turbine engine is provided. The gas turbine engine includes a case and a vane assembly connected to the case. The vane assembly includes an outer platform, an inner platform, and a vane. The outer platform is disposed proximate the case. The outer platform has a first rail extending towards the case. The first rail has a first face, a second face disposed opposite the first face, and a first opening extending from the first face towards the second face. The inner platform is disposed opposite the outer platform. The vane extends between the inner platform and the outer platform.

In addition to one or more of the features described above, or as an alternative to any of the foregoing embodiments, the first opening includes a first side surface extending from the first face towards a first support surface, a second side surface disposed opposite the first side surface extending from the first face towards a second support surface, and a first opening surface extending between the first side surface and the second side surface, the first opening surface extending from the first face towards a third support surface that extending between the first support surface and the second support surface.

In addition to one or more of the features described above, or as an alternative to any of the foregoing embodiments, the first rail defines a second opening extending from the second face towards the first face.

In addition to one or more of the features described above, or as an alternative to any of the foregoing embodiments, the second opening includes a third side surface extending from the second face towards a fourth support surface, a fourth side surface disposed opposite the third side surface extending from the second face towards a fifth support surface, and a second opening surface extending from the second face towards a sixth support surface.

In addition to one or more of the features described above, or as an alternative to any of the foregoing embodiments, a seal is received within a slotted region disposed between the first support surface, the second support surface, the third support surface, the fourth support surface, the fifth support surface, and the sixth support surface.

In addition to one or more of the features described above, or as an alternative to any of the foregoing embodiments, the seal has a seal body extending between a first seal face and a second seal face.

In addition to one or more of the features described above, or as an alternative to any of the foregoing embodiments, the first seal face engages the first support surface, the second support surface, and the third support surface and the second seal face engages the fourth support surface, the fifth support surface, and the sixth support surface.

In addition to one or more of the features described above, or as an alternative to any of the foregoing embodiments, the first opening has a first width and the second opening has a second width that is less than the first width.

In addition to one or more of the features described above, or as an alternative to any of the foregoing embodiments, the slotted region has a slotted region width that is greater than the first width.

In addition to one or more of the features described above, or as an alternative to any of the foregoing embodiments, the case includes a mounting feature, the mounting feature having a first mounting feature portion extending from the case and a second mounting feature portion disposed perpendicular to the first mounting feature and extending towards the first rail.

In addition to one or more of the features described above, or as an alternative to any of the foregoing embodiments, the first rail has a rail member extending from the first face towards the mounting feature.

In addition to one or more of the features described above, or as an alternative to any of the foregoing embodiments, the second mounting feature portion is disposed between the rail member and the outer platform.

According to another embodiment of the present disclosure, a vane assembly for a gas turbine engine is provided. The vane assembly includes an outer platform, an inner platform, a vane, and a seal. The outer platform is disposed proximate a case. The outer platform has a first rail extending towards the case. The first rail has a first face, a second face disposed opposite the first face, and a first opening extending from the first face towards the second face. The inner platform is disposed opposite the outer platform. The vane extends between the inner platform and the outer platform. The seal is received within a slotted region that is disposed between the first face and the second face.

In addition to one or more of the features described above, or as an alternative to any of the foregoing embodiments, the first rail has a first rail member extending from the first face and a second rail member spaced apart from the first rail member extending from the first face.

In addition to one or more of the features described above, or as an alternative to any of the foregoing embodiments, the slotted region is disposed between the first rail member and the second rail member.

In addition to one or more of the features described above, or as an alternative to any of the foregoing embodiments, the first rail defines a first opening extending from the first face towards the second face.

In addition to one or more of the features described above, or as an alternative to any of the foregoing embodiments, the first rail defines a second opening extending from the second face towards the first face.

In addition to one or more of the features described above, or as an alternative to any of the foregoing embodiments, the first opening is spaced apart from the second opening by the slotted region.

In addition to one or more of the features described above, or as an alternative to any of the foregoing embodiments, the seal the seal has a seal body extending between a first seal end and a second seal end.

In addition to one or more of the features described above, or as an alternative to any of the foregoing embodiments, the second end includes a curved portion curving towards the first face and extending over the first opening.

### BRIEF DESCRIPTION OF THE DRAWINGS

The subject matter which is regarded as the present disclosure is particularly pointed out and distinctly claimed in the claims at the conclusion of the specification. The foregoing and other features, and advantages of the present disclosure are apparent from the following detailed description taken in conjunction with the accompanying drawings in which:

FIG. 1 is a schematic view of a gas turbine engine;

FIG. 2 is a partial side view of a vane assembly attached to a case of the gas turbine engine;

FIG. 3 is a partial front view of the vane assembly;

FIG. 4 is a partial perspective view of a first rail of the vane assembly;

FIG. 5 is a partial perspective view of a seal received within a slotted region of the first rail of the vane assembly; and

FIG. 6 is a perspective view of the seal.

### DETAILED DESCRIPTION

Referring now to the Figures, where the present disclosure will be described with reference to specific embodiments, without limiting same, it is to be understood that the disclosed embodiments are merely illustrative of the present disclosure that may be embodied in various and alternative forms. Various elements of the disclosed embodiments may be combined or omitted to form further embodiments of the present disclosure. The Figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present disclosure.

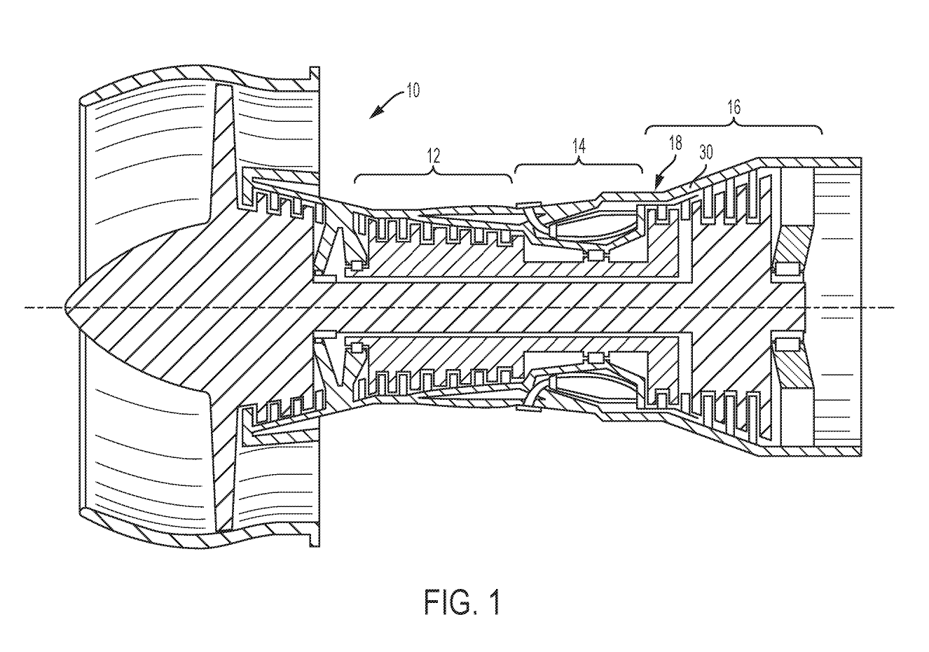

Referring to FIG. 1, a gas turbine engine 10 is schematically shown. The gas turbine engine 10 includes a compressor section 12, a combustor section 14, and a turbine section 16 that are disposed within a case assembly 18. Intake air is compressed by the compressor section 12 and is directed to the combustor section 14. Within the combustor section 14 the compressed air is heated. The heated compressed air is directed to the turbine section 16 where the energy is extracted by a plurality of turbine blades of the turbine section 16.

The case assembly 18 extends about the compressor section 12, the combustor section 14, and the turbine section 16. The case assembly 18 may include a plurality of cases 30 that are joined together. The plurality of cases 30 that are joined together may have varying configurations to accommodate a respective section of the gas turbine engine 10.

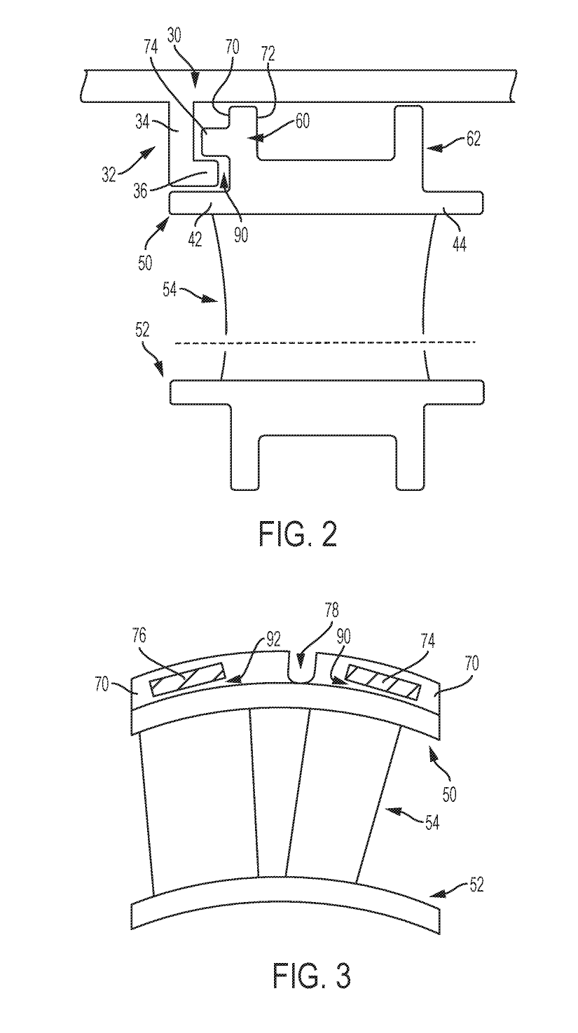

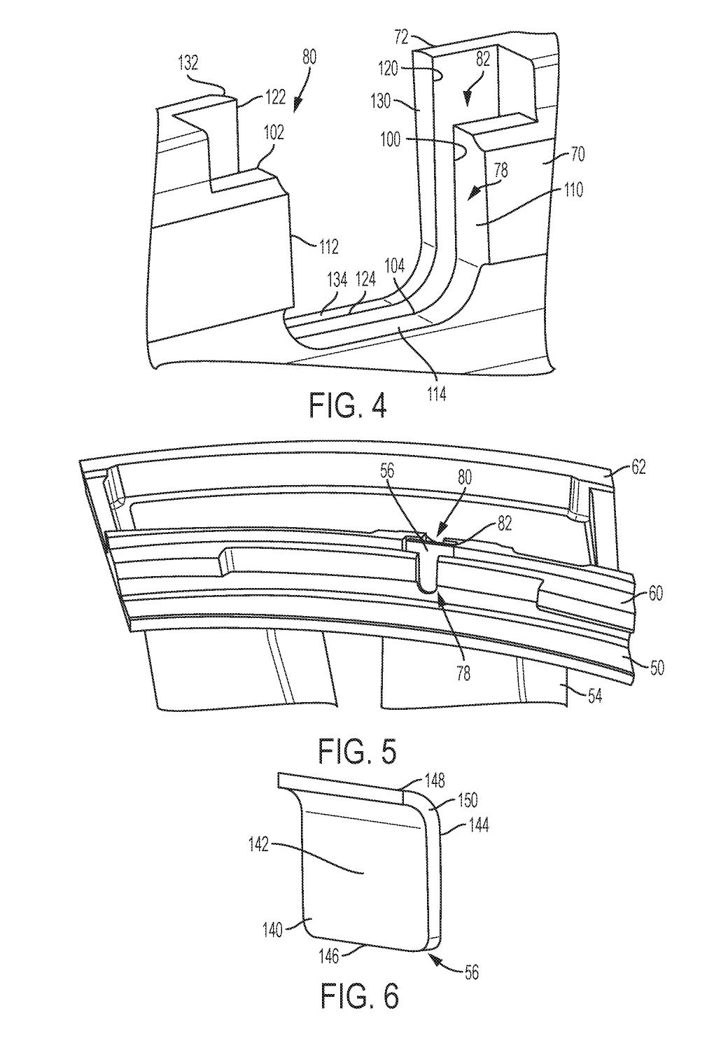

Referring to FIGS. 2-6, a case of the plurality of cases 30 includes a mounting feature 32. The mounting feature 32 is configured as a rail having a hooked portion that extends circumferentially about an inner surface of a case of the plurality of cases 30. The mounting feature 32 extends from the case and includes a first mounting feature portion 34 and a second mounting feature portion 36. The first mounting feature portion 34 is disposed substantially perpendicular to the case. The second mounting feature portion 36 extends from the first mounting feature portion 34. The second mounting feature portion 36 is disposed substantially perpendicular to the first mounting feature portion 34. The second mounting feature portion 36 is disposed substantially parallel to the case. The second mounting feature 34 may have a curvilinear shape when viewed in cross-section that has a radius of curvature substantially similar to the curvature of the case.

The intake air that is compressed, heated and directed to the plurality of turbine blades by at least one vane assembly 40. The vane assembly 40 may be configured as a turbine vane assembly or a compressor vane assembly. The vane assembly 40 has a first end 42 and a second end 44. The vane assembly 40 is connected to the case by the mounting feature 32 at the first end 42. The vane assembly 40 includes an outer platform 50, an inner platform 52, a vane 54, and the seal 56.

The outer platform 50 is disposed proximate the case. The inner platform 52 is spaced apart from and is disposed opposite the outer platform 50. The vane 54 is configured as an airfoil that extends between the outer platform 50 and the inner platform 52.

The outer platform 50 includes a first rail 60 and a second rail 62. The first rail 60 extends from the outer platform 50 towards the case. The first rail 60 is disposed proximate the first end 42 of the vane assembly 40. The first rail 60 acts as a pressure wall that takes a pressure drop across the vane assembly 40.

The first rail 60 includes a first face 70, a second face 72, a first rail member 74, a second rail member 76, a first opening 78, a second opening 80, and a slotted region 82. The first face 70 extends from an end of the first rail 60 disposed proximate the outer platform 50 towards and end of the first rail 60 disposed proximate the case. The second face 72 is disposed opposite the first face 70. The second face 72 is disposed substantially parallel to the first face 70.

The first rail member 74 extends from the first face 70 towards the mounting feature 32. The first rail member 74 is disposed substantially perpendicular to the first face 70. The first rail member 74, the first face 70, and a portion of the outer platform 50 define an opening 90. The opening 90 is configured to receive at least a portion of the second mounting feature portion 36 of the mounting feature 32 to mount the vane assembly 40 to the case of the plurality of cases 30.

The second rail member 76 is radially spaced apart from the first rail member 74. The second rail member 76 extends from the first face 70 towards the mounting feature 32. The second rail member 76, the first face 70, and a portion of the outer platform 50 define another opening 92. The another opening 92 is configured to receive at least a portion of the second mounting feature portion 36 of the mounting feature 32 to mount the vane assembly 40 to the case of the plurality of cases 30.

The first opening 78 is disposed between the first rail member 74 and the second rail member 76. The first opening 78 is defined by the first rail 60. The first opening 78 extends from the first face 70 towards the second face 72. The first opening 78 extends from the first face 70 towards a first support surface 100, a second support surface 102, and a third support surface 104. The first support surface 100 and the second support surface 102 are spaced apart from each other by the first opening 78. The third support surface 104 extends between the first support surface 100 and the second support surface 102. The first support surface 100, the second support surface 102, and the third support surface 104 are disposed between the first face 70 and the second face 72. The first support surface 100, the second support surface 102, and the third support surface 104 are disposed substantially parallel to the first face 70 and the second face 72.

The first opening 78 includes a first side surface 110, a second side surface 112, and a first opening surface 114. The first side surface 110 extends from the first face 70 to the first support surface 100. The second side surface 112 is disposed opposite the first side surface 110. The second side surface 112 extends from the first face 70 to the second support surface 102. The first opening surface 114 extends between the first side surface 110 and the second side surface 112. The first opening surface 114 extends from the first face 70 to the third support surface 104. The first opening 78 has a first width.

The second opening 80 is disposed between the first rail member 74 and the second rail member 76. The second opening 80 is disposed substantially co-linearly or coaxially with the first opening 78. The second opening 80 is defined by the first rail 60.

The second opening 80 extends from the second face 72 towards the first face 70. The second opening 80 extends from the second face 72 towards a fourth support surface 120, a fifth support surface 122, and a sixth support surface 124. The fourth support surface 120 and the fifth support surface 122 are spaced apart from each other by the second opening 80. The sixth support surface 124 extends between the fourth support surface 120 and the fifth support surface 122. The fourth support surface 120, the fifth support surface 122, and the sixth support surface 124 disposed between the second face 72 and the first face 70. The fourth support surface 120, the fifth support surface 122, and the sixth support surface 124 are spaced apart from the first support surface 100, the second support surface 102, and the third support surface 104. The fourth support surface 120, the fifth support surface 122, and the sixth support surface 124 are disposed substantially parallel to the first support surface 100, the second support surface 102, and the third support surface 104. The fourth support surface 120, the fifth support surface 122, and the sixth support surface 124 are disposed substantially parallel to the second face 72 and the first face 70.

The second opening 80 includes a third side surface 130, a fourth side surface 132, and a second opening surface 134. The third side surface 130 extends from the second face 72 to the fourth support surface 120. The fourth side surface 132 is disposed opposite the third side surface 130. The fourth side surface 132 extends from the second face 72 to the fifth support surface 122. The second opening surface 134 extends between the third side surface 130 and the fourth side surface 132. The second opening surface 134 extends from the second face 72 to the sixth support surface 124. The second opening 80 has a second width. The second width is less than the first width.

The first opening 78 is spaced apart from the second opening 80 by the slotted region 82. Slotted region 82 is defined between the first support surface 100, the second support surface 102, the third support surface 104, the fourth support surface 120, the fifth support surface 122, and the sixth support surface 124. The slotted region 82 has a slotted region width that is greater than the first width.

The first opening 78 and the second opening 80 lowers stresses that are experienced by the vane assembly 40. The first opening 78 and the second opening 80 reduces stresses between a fillet that extends between the outer platform 50 and the vane 54 to connect the outer platform 50 to the vane 54. The first opening 78 and the second opening 80 soften the first rail 60 to reduce stresses.

The second rail 62 is disposed proximate the second end 44 of the vane assembly 40. The second rail 62 extends from the outer platform 50 towards the case. In at least one embodiment, the second rail 62 may be provided with the first opening 78, the second opening 80, and the slotted region 82 disposed between the first opening 78 and the second opening 80. The first opening 78, the second opening 80, and the slotted region 82 may have a substantially similar configuration as previously described.

The seal 56 is received within the slotted region 82 that is disposed between the first opening 78 and the second opening 80 of at least one of the first rail 60 and the second rail 62. The seal 56 includes a seal body 140. The seal body 140 extends between a first seal face 142 and a second seal face 144. The first seal face 142 engages the first support surface 100, the second support surface 102, and the third support surface 104. The second seal face 144 engages the fourth support surface 120, the fifth support surface 122, and the sixth support surface 124.

The seal body 140 extends between a first seal end 146 and a second seal end 148. The first seal end 146 is disposed proximate the outer platform 50. The second seal end 148 is disposed opposite the first seal end 146. The second seal end 148 includes a curved portion 150. The curved portion 150 curves towards the first face 70. The curved portion 150 has an arcuate profile and extends at least partially over the first opening 78.

Throughout this specification, the term “attach,” “attachment,” “connected”, “coupled,” “coupling,” “mount,” or “mounting” shall be interpreted to mean that a structural component or element is in some manner connected to or contacts another element, either directly or indirectly through at least one intervening structural element, or is integrally formed with the other structural element.

While the present disclosure has been described in detail in connection with only a limited number of embodiments, it should be readily understood that the present disclosure is not limited to such disclosed embodiments. Rather, the present disclosure can be modified to incorporate any number of variations, alterations, substitutions or equivalent arrangements not heretofore described, but which are commensurate with the scope of the present disclosure. Additionally, while various embodiments of the present disclosure have been described, it is to be understood that aspects of the present disclosure may include only some of the described embodiments. Accordingly, the present disclosure is not to be seen as limited by the foregoing description, but is only limited by the scope of the appended claims.

1. A gas turbine engine, comprising:
a case; and
a vane assembly connected to the case, the vane assembly comprising:
an outer platform disposed proximate the case, the outer platform having a first rail extending towards the case, the first rail having a first face, a second face disposed opposite the first face, and a first opening extending from the first face towards the second face,
an inner platform disposed opposite the outer platform, and
a vane extending between the inner platform and the outer platform.

2. The gas turbine engine of claim 1, wherein the first opening includes a first side surface extending from the first face towards a first support surface, a second side surface disposed opposite the first side surface extending from the first face towards a second support surface, and a first opening surface extending between the first side surface and the second side surface, the first opening surface extending from the first face towards a third support surface that extending between the first support surface and the second support surface.

3. The gas turbine engine of claim 2, wherein the first rail defines a second opening extending from the second face towards the first face.

4. The gas turbine engine of claim 3, wherein the second opening includes a third side surface extending from the second face towards a fourth support surface, a fourth side surface disposed opposite the third side surface extending from the second face towards a fifth support surface, and a second opening surface extending from the second face towards a sixth support surface.

5. The gas turbine engine of claim 4, further comprising a seal received within a slotted region disposed between the first support surface, the second support surface, the third support surface, the fourth support surface, the fifth support surface, and the sixth support surface.

6. The gas turbine engine of claim 5, wherein the seal has a seal body extending between a first seal face and a second seal face.

7. The gas turbine engine of claim 6, wherein the first seal face engages the first support surface, the second support surface, and the third support surface and the second seal face engages the fourth support surface, the fifth support surface, and the sixth support surface.

8. The gas turbine engine of claim 7, wherein the first opening has a first width and the second opening has a second width that is less than the first width.

9. The gas turbine engine of claim 8, wherein the slotted region has a slotted region width that is greater than the first width.

10. The gas turbine engine of claim 1, wherein the case includes a mounting feature, the mounting feature having a first mounting feature portion extending from the case and a second mounting feature portion disposed perpendicular to the first mounting feature and extending towards the first rail.

11. The gas turbine engine of claim 10, wherein the first rail has a rail member extending from the first face towards the mounting feature.

12. The gas turbine engine of claim 11, wherein the second mounting feature portion is disposed between the rail member and the outer platform.

13. A vane assembly for a gas turbine engine, the vane assembly comprising:
an outer platform disposed proximate a case, the outer platform having a first rail extending towards the case, the first rail having a first face, a second face disposed opposite the first face, and a first opening extending from the first face towards the second face;
an inner platform disposed opposite the outer platform;
a vane extending between the inner platform and the outer platform; and
a seal received within a slotted region disposed between the first face and the second face.

14. The vane assembly of claim 13, wherein the first rail has a first rail member extending from the first face and a second rail member spaced apart from the first rail member extending from the first face.

15. The vane assembly of claim 14, wherein the slotted region is disposed between the first rail member and the second rail member.

16. The vane assembly of claim 15, wherein the first rail defines a first opening extending from the first face towards the second face.

17. The vane assembly of claim 16, wherein the first rail defines a second opening extending from the second face towards the first face.

18. The vane assembly of claim 17, wherein the first opening is spaced apart from the second opening by the slotted region.

19. The vane assembly of claim 18, wherein the seal the seal has a seal body extending between a first seal end and a second seal end.

20. The vane assembly of claim 19, wherein the second end includes a curved portion curving towards the first face and extending over the first opening.
